(19) United States
(12) Patent Application Publication
(10) Pub. No.: US 2012/0240413 A1
(43) Pub. Date: Sep. 27, 2012

(54) Rotating head multi-angled cutting knife

(76) Inventors: Elwood Dean Quimby, Derby, KS (US); Hubert J. Bung, Wichita, KS (US)

(21) Appl. No.: 13/385,981

(22) Filed: Mar. 19, 2012

Related U.S. Application Data
(60) Provisional application No. 61/465,471, filed on Mar. 21, 2011.

(51) Int. Cl. B26B 1/04; B26B 5/00

(52) U.S. Cl. 30/161; 30/321

(57) ABSTRACT

A knife that consist of a handle with a lockable and rotatable cutter head. The handle has a locking mechanism that secures the cutter head in numerous cutting positions and also in a safety position.

The cutter head contains the blade. After the edges gets dull the blade can be rotated within the cutter head to allow for the use of new cutting edges.

The blade can easily be replaced by loosening the cutter head pivot bolt. The cutter head and pivot bolt remain attached to the knife during this process.

### CROSS-REFERENCES TO RELATED APPLICATION

U.S. Pat. No. 5,400,512
U.S. Pat. No. 6,796,033
U.S. Pat. No. 4,730,394
U.S. Pat. No. 3,518,758
U.S. Pat. No. 7,093,367
U.S. Pat. No. 4,504,091
U.S. Pat. No. 4,856,385

This application claims the benefit of provisional patent application 13/199,206 and 61/465,471 filed Mar. 21, 2011 by present inventors

### BACKGROUND

1. Field

This application relates to various cutters including the common utility knives and knives with blade to knife angle or blade angle to handle adjustments.

2. Prior Art

Conventional knives such as the common utility knives are well known in the art. These knives have many industrial as well as home uses. A typical knife allows the blade to be adjusted in a forward or retracted position.

The typical knife has the blade in a single fixed angle cutting position. There are adjustable knife handles that allow for different blade to handle angles. None of these are designed to use the triangular blade along with other blade designs.

There is a need for an improved knife that provides additional features and options for the consumers.

The rotating head Multi Angle cutting knife has a dual locking head engagement feature. This provides a maximum lock when engaged.

### SUMMARY

Accordingly, the object of the new invention is having a knife that is able to adjust to numerous cutting angles and positions for practical and ergonomic purposes. The knife will have use of two cutting blade areas at a time when in the cutting mode. It's 360 degree rotating head also allows the blade to be placed in a safe position when not in use.

Other aspects and advantages of the present invention will become more readily apparent in view of the following detail description and accompanying drawings.

### BRIEF DESCRIPTION OF DRAWINGS

FIG. 1 Shows exploded view of all the parts that make up the cutter.

FIG. 2 Shows top, side and bottom view of case half with window for slide lock.

FIG. 3 Shows top, side and bottom view of case half without.

FIG. 4 Side view, end view and isometric view of the cutters head.

FIG. 5 Two isometric views of the slide lock.

FIG. 6 Shows the cutter head pivot bolt, compression spring and retaining clip.

FIG. 7 The isometric view of slide lock in forward position engaged with cutter head.

FIG. 8 Shows two cut away views of the cutters handle displaying the spring with slide lock in the locked position.

FIG. 9 Detailed view of flex member, slide engagement hook and lock engagement notches.

FIG. 10 Shows the slide lock movement. The upper view shows the slide lock in the forward/engaged and the other view shows it in the retracted/disengaged position.

FIG. 11 Depicts the isometric views of both sides of the cutter in the locked and safe position.

FIG. 12 Side view of knife in different head/blade angle position.

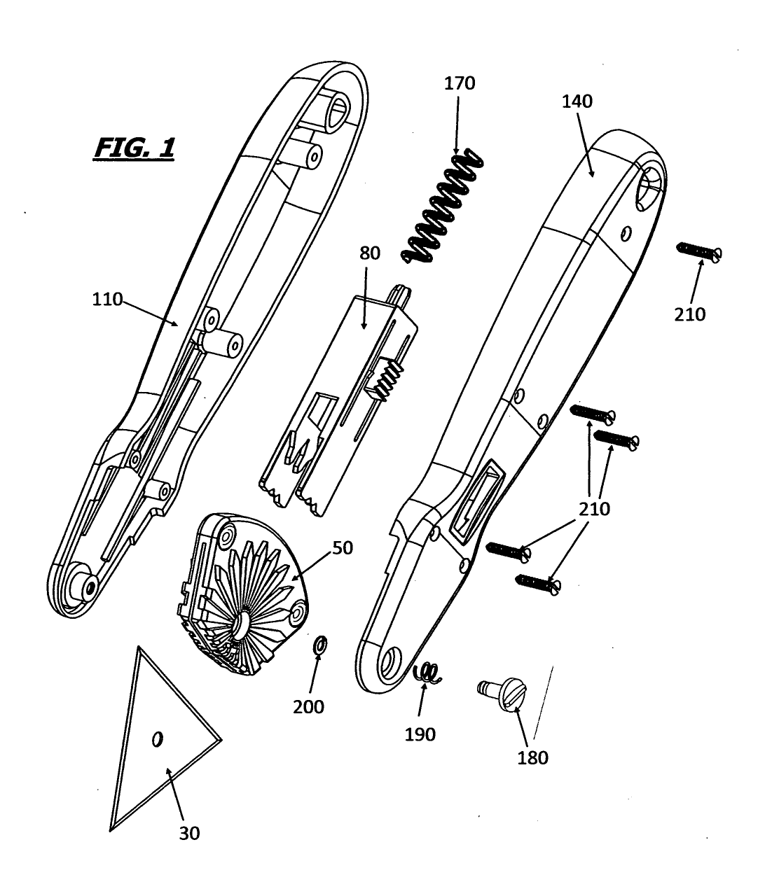

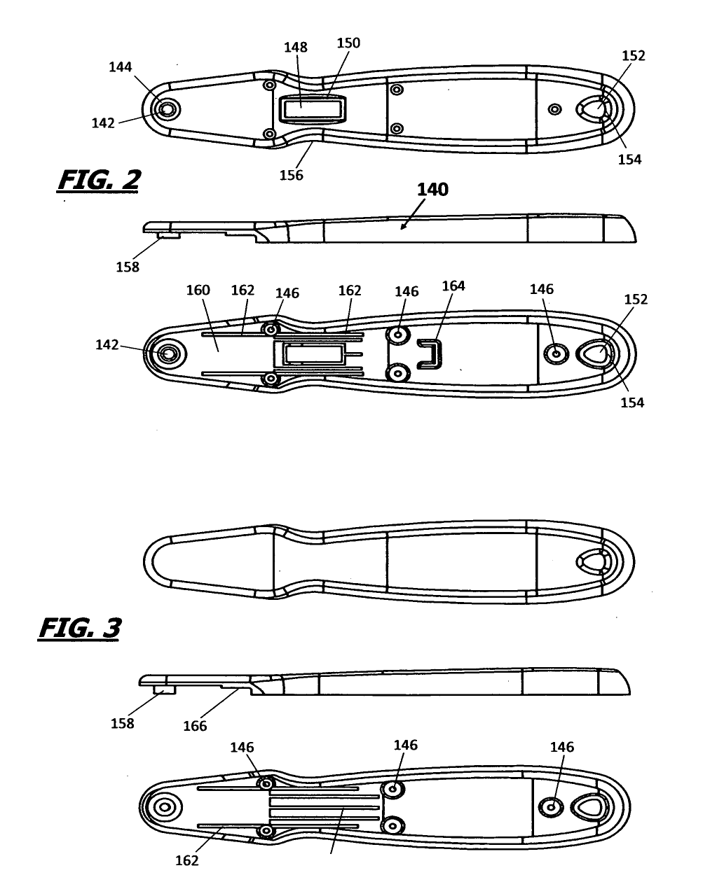

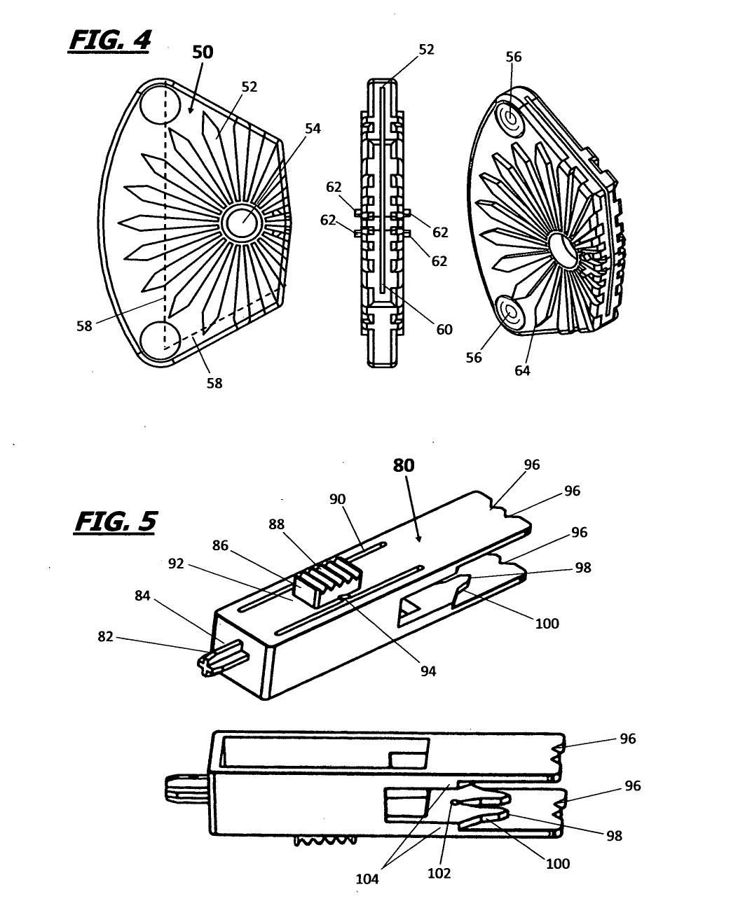

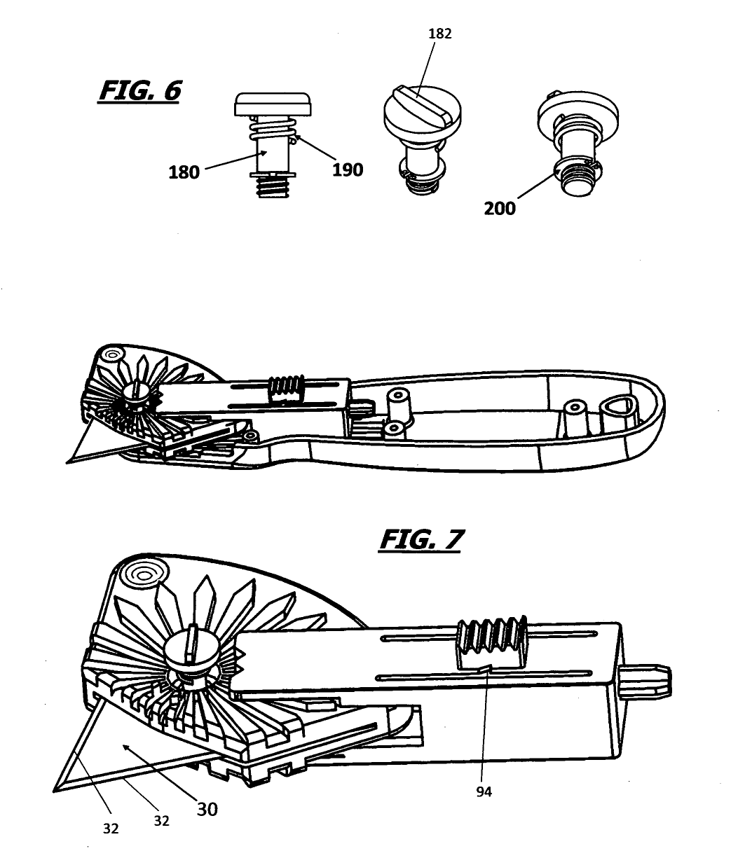

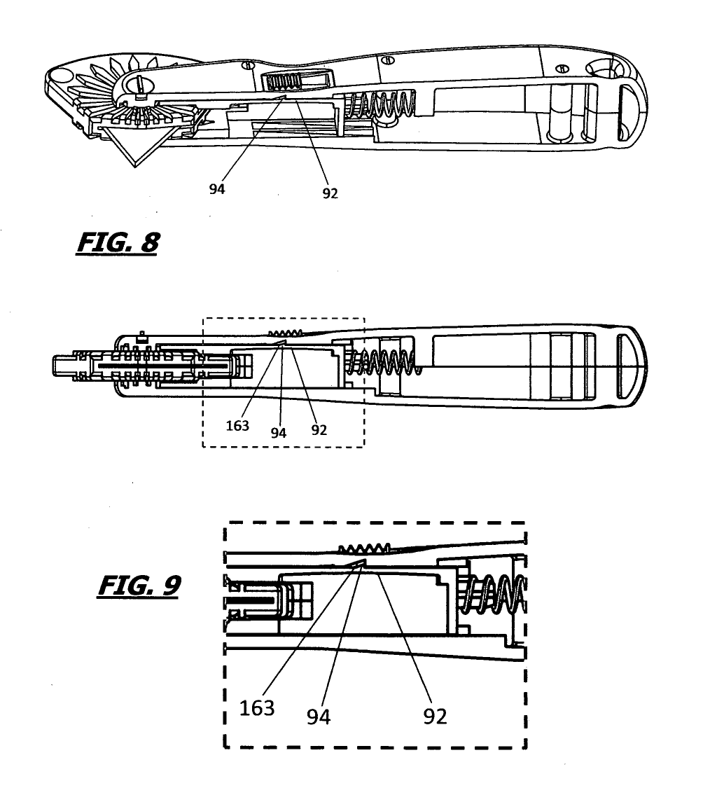

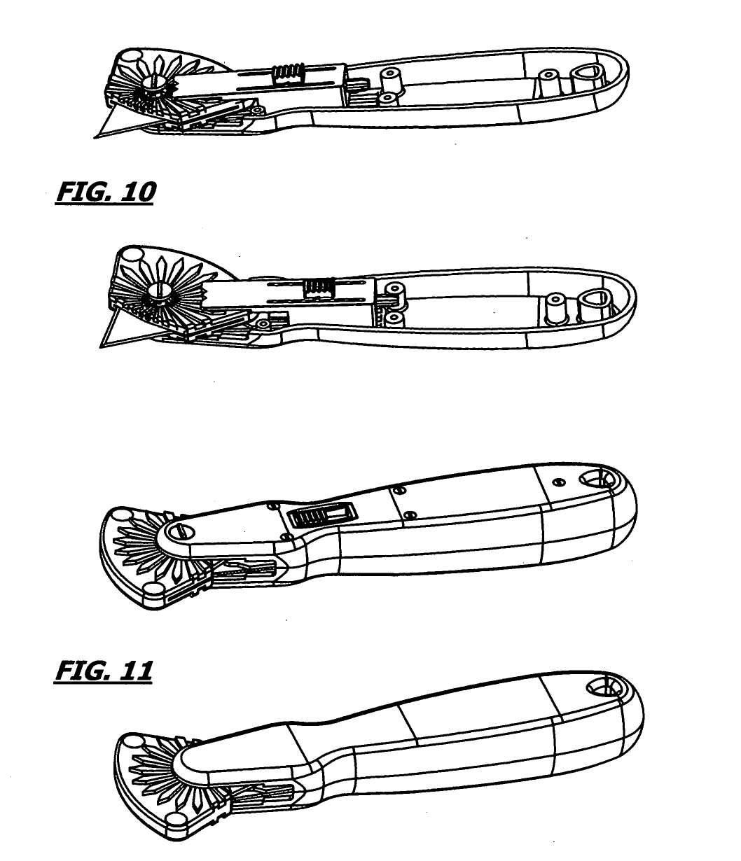

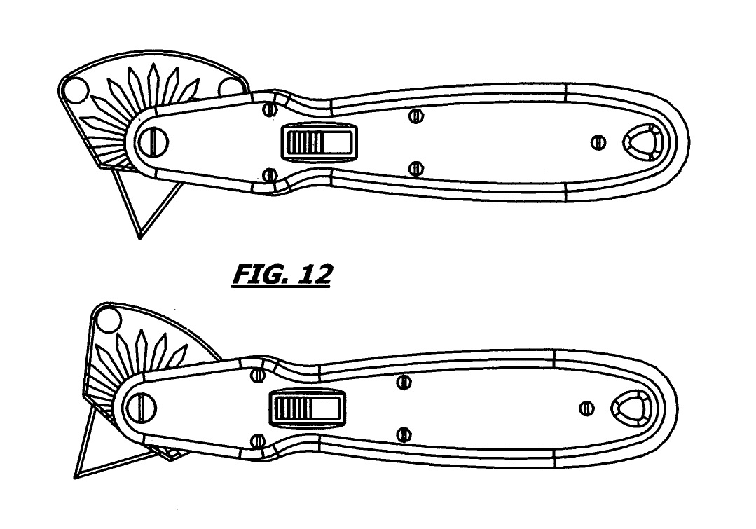

### REFERENCE NUMERAL

30 Blade
32 Blade cutting Edge
50 Cutter Head
52 Head Lock Rib
54 Head pivot hole
56 Finger Grip recess
58 Interior blade stop
60 Blade mounting slot
62 Safety lock Pegs
64 Locking alignment points
80 Lock
82 Spring lead in chamfer
84 Spring retaining boss
86 Finger push boss
88 Finger grip
90 Relief slots
92 Flex member
94 Slide engagement hook
96 Head safety lock feature
98 Alignment points
100 Head position locking fingers
102 Alignment point clearance
104 Double lock feature
110 Knife half without lock sliding window
140 Knife half with locks sliding window
142 Pivot hole
144 Bolt recess
146 Screw retaining hole
148 Slide lock window
150 Window recess
152 Handle hanging hole
154 Hole lead in
156 Finger grip area
158 Pivot boss
160 Lock slide area
162 Slide guide
163 Lock engagement notches
164 Spring retainer
166 Cutter Head pivot area
168 Lock slide ribs
170 Lock position spring
180 Cutter Head pivot bolt
182 Finger recess dimple
190 Compression spring
200 Bolt retaining clip
210 Mounting screws

### DETAILED DESCRIPTIONS

The knife is designed to use a triangular shaped blade. It has a reversible grip feature which allows the user to cut with one side of the triangular blade and when dull just turn the knife handle over 180 degrees for a new cutting surface. When the two cutting surfaces are dull the blade can be removed and rotated allowing for two more new cutting surfaces. This can be repeated one more time giving two more new cutting surfaces. The blades can easily be removed and replaced without the use of tools.

The cutter head can be rotated 360 degrees and placed in numerous cutting positions and also be rotated to the save position when not in use. This allows the blade to be hidden safely within the knife handle.

The cutting head can be retrofitted to use the common utility blades or other blade designs.

1. A knife with a cutter head that rotates 360 degrees and has various angle settings allowing a multitude of different locking adjustment positions.

2. A knife featured with bi directional cutting options.

3. A knife with optional double lock or single sided lock engagement.

4. A knife with a quick engaged and disengage locking position feature.

5. Blade can be replaced while leaving head and knife connected.

6. Blade can easily be locked in a safety position.
